(19) United States
(12) Patent Application Publication
(10) Pub. No.: US 2026/0006044 A1
(43) Pub. Date: Jan. 1, 2026

(54) IDENTIFYING AND REMEDIATING SCAM ELECTRONIC MESSAGES

(71) Applicant: RANGERS.AI, Boca Raton, FL (US)

(72) Inventor: Ayelet Dawn Biger-Levin, Boca Raton, FL (US)

(21) Appl. No.: 19/253,030

(22) Filed: Jun. 27, 2025

Related U.S. Application Data
(60) Provisional application No. 63/666,000, filed on Jun. 28, 2024.

(51) Int. Cl. H04L 9/40; G06Q 30/018; G06Q 50/00

(52) U.S. Cl. CPC H04L 63/1416; G06Q 30/0185; G06Q 50/01; H04L 63/123; H04L 63/1441

(57) ABSTRACT

One embodiment provides a computer-implemented method that includes receiving, by a processor, an indication of messaging applications to monitor, specifying a risk threshold. The processor further provides a notification to at least one device. The notification includes an identified scam message from the messaging applications. The processor additionally provides step-by-step guidance on actions to take to the at least one device.

### CROSS-REFERENCE TO RELATED APPLICATIONS

This application claims the priority benefit of U.S. Provisional Patent Application Ser. No. 63/666,000, filed Jun. 28, 2024, which is incorporated herein by reference in its entirety.

### TECHNICAL FIELD

The embodiments relate to methods and systems for managing electronic messaging and, more particularly, a method for identifying scam electronic messages on a server, mobile applications (or mobile apps), and desktop computers using machine learning (ML) and natural language processing (NLP).

### BACKGROUND

Given that credit card issuers and financial institutions have improved technology that identifies online fraud, such as new account fraud and account takeover, cybercriminals with financial motivation have turned to the “weakest” link”—humans. Online financial scams are a method of socially engineering a victim, or the use of deception, to manipulate individuals into committing an act they have not intended, for identity and financial theft. In 2023, the FBI received 880,413 complaints of online scams, and reported losses exceeding US $12.5 billion up from $10.3 billion in 2022. Some examples of such scams include Impersonation Scams, Investment Scams, Romance Scams, IT Helpdesk Scams, Crypto Investment Scams, Business Compromise Scams, Sextortion scams, PayPal® scams, UPS®/Shipping scams, fake notices from the bank, etc.

Besides the monetary loss, the emotional toll that these scams have on their victims can be irreversible, and some victims suffer from long lasting PTSD. It can rip families apart and even lead to suicide, with over 40 cases of teens reportedly died by suicide since 2021 due to Sextortion scams. There is a tremendous amount of shame and guilt by victims. Once someone takes the bait, the perpetrators use psychological tactics ranging from fear (e.g., “we charged your account for $400, call us if you didn't make this payment”) to delight (e.g., “you've won this amazing cruise for free, just give me all of your personal information”). The perception is that victims of such scams are less tech savvy, more vulnerable, or elderly, but the reality is, it can happen to anyone. However, online scams go mostly unreported and people often do not seek help as they do not think they will get their money back, and some think it is their fault for “falling” for a scam, although they are manipulated by organized crime rings. Governments and financial institutions offer some training to consumers; however, it is not effective because there is always a gap between the provided awareness materials and the actual scams that hit consumers. Once someone is manipulated by the criminal, it is very hard to stop the scam. Financial institutions often attempt to put scam detection controls on the payment rails, analyzing risk signals, however, due to the social engineering and manipulation, it is very hard for them to convince the consumer that they should not proceed with the payment. This is why prevention is critical.

In order to prevent scams, analyzing messages exchanged online with strangers is a method of identifying a potential scam. Messaging applications are bound by privacy laws and so drive solutions such as server-side encryption (which is available for some communications). Server-side analysis limits the ability to read and analyze messages. “On-device” analysis, on the other hand, allows access to more applications, including those which encrypt data on the server and in transit. In addition, detecting high-risk messages is only one part. Providing binary assessment can be risky due to the nature of machine learning (ML) that is probabilistic. Rather than saying—this is a scam, it is appropriate to say—this is a high-risk message, and this is the starting point to confirm or dispute the case. Guidance in the moment is key.

U.S. Pat. No. 10,944,790 and U.S. Published patent application No. 20190149575 describe methods of detecting scam messages by analyzing data on the server. However, many messaging applications are encrypted and therefore data on the server is not readable.

In addition, other inventions are related to known scam numbers and callers or related to scam calls, e.g., U.S. Pat. No. 10,542,137, which do not work on volume of messages from a single number or known scam callers.

As can be seen, there is a need for a method for identifying scam electronic messages extending from a cloud or server to mobile devices, mobile applications and desktop computers using ML and NLP.

### SUMMARY

The present invention focuses on the content of the message, wherein the originator of the message does not have to be known.

A method to distinguish between scam messages and non-scam messages delivered via messaging platforms on mobile devices (e.g., smart phones, pad devices, etc.) and desktops, providing users with in-context alerts for scam likelihood and providing clear guidance on what actions to take is embodied in the present invention. The method scans messages across the messaging applications, such as email, SMS, WHATSAPP®, dating apps, and others, and identifies messages that are high-risk (e.g., “time bombs” are similar to previous known scam messages or contain known deceptive language). The analysis is done through a combination of machine learning (ML) leveraging natural language processing (NLP) and may also use filtering rules. Once a message is deemed high-risk, users will get an alert on their device, explaining why the message was deemed high-risk, the type of scam it is suspected to be, and will get in-context education on how the scam works as well as guidance on what actions to take to keep themselves safe based on the content of the message. For example, if the message is deemed as high-risk and a fake payment scam, the user will receive an explanation of how the scam works (in a fake payment scam, a scammer tries to convince the victim that they have received a large payment. This is usually conducted by sending an email that appears as a legitimate payment confirmation. The scammer then asks for part of the payment back, such as claiming that they sent too much money. Once the scammer receives the victim's payment, they disappear with no way for the victim to get their money back. Next, the user will receive guidance:
Don't reply: Never contact the phone number or email listed in the message, always use companies' official support lines.
Verify with Official Channels: Contact the company directly using their official website or phone number to dispute or verify the payment.
Avoid clicking links: Links may lead to fraudulent websites or install malware on your device.

In addition, users can add another layer of protection by adding guardians from their contact list. Guardians, who are less likely to get emotionally involved in a scam, will also receive the alerts for the protected user and will be able to guide users, such as the case of vulnerable populations (elderly, autism, etc.). The scope is multilingual.

Other inventions today provide some methods of detecting scam messages but do not work “on-device” and do not provide notification and appropriate context guidance to users.

One embodiment provides a computer-implemented method that includes receiving, by a processor, an indication of one or more messaging applications to monitor, specifying a risk threshold. The processor further provides at least one notification to one or more devices, wherein the at least one notification comprises one or more identified scam messages from the one or more messaging applications. The processor additionally provides step-by-step guidance on actions to take to the one or more devices.

Another embodiment provides a method that includes receiving an indication of one or more messaging applications to monitor, specifying a risk threshold. The method further provides providing at least one notification to one or more devices. The at least one notification includes one or more identified scam messages from the one or more messaging applications. The method additionally provides step-by-step guidance on actions to take to the one or more devices.

Yet another embodiment provides an apparatus including a memory storing instructions, and at least one processor that executes the instructions including a process configured to receive an indication of one or more messaging applications to monitor, specifying a risk threshold. The processor is further configured to provide at least one notification to one or more devices. The at least one notification comprises one or more identified scam messages from the one or more messaging applications. The at least one processor is additionally configured to provide step-by-step guidance on actions to take to the one or more devices.

These and other features, aspects and advantages of the one or more embodiments will become understood with reference to the following description, appended claims and accompanying figures.

### BRIEF DESCRIPTION OF THE DRAWINGS

For a fuller understanding of the nature and advantages of the embodiments, as well as a preferred mode of use, reference should be made to the following detailed description read in conjunction with the accompanying drawings, in which:

FIG. 1 is a schematic view of an exemplary embodiment including a setup mode, according to some embodiments;

FIG. 2 is a continuation of FIG. 1, representing a runtime mode, according to some embodiments;

FIG. 3 is a continuation of FIG. 2, including a model creation and update mode, according to some embodiments;

FIG. 4 illustrates a process for distinguishing between scam messages and non-scam messages delivered via messaging platforms on mobile devices and desktops, according to some embodiments;

FIG. 5 illustrates a high-level block diagram showing an information processing system comprising a computer system useful for implementing the disclosed embodiments; and

FIGS. 6A-H illustrate example screen views of a mobile app, according to some embodiments.

### DETAILED DESCRIPTION

The following description is made for the purpose of illustrating the general principles of one or more embodiments and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc.

A description of example embodiments is provided on the following pages. The text and figures are provided solely as examples to aid the reader in understanding the disclosed technology. They are not intended and are not to be construed as limiting the scope of this disclosed technology in any manner. Although certain embodiments and examples have been provided, it will be apparent to those skilled in the art based on the disclosures herein that changes in the embodiments and examples shown may be made without departing from the scope of this disclosed technology.

The embodiments relate to methods and systems for managing electronic messaging and, more particularly, a method for identifying scam electronic messages on a server, mobile applications (mobile apps), and desktop computers using machine learning (ML) and natural language processing (NLP). One or more embodiments relate to ML models or algorithms that employ one or more artificial intelligence (AI) models or algorithms. AI models may include a trained ML model (e.g., models, such as a neural network (NN), a convolutional NN (CNN), a recurrent NN (RNN), a Long short-term memory (LSTM) based NN, gate recurrent unit (GRU) based RNN, tree-based CNN, K-nearest neighbor (KNN) as a NN, a self-attention network (e.g., a NN that utilizes the attention mechanism as the basic building block; self-attention networks have been shown to be effective for sequence modeling tasks, while having no recurrence or convolutions), BiLSTM (bi-directional LSTM), etc.). An artificial NN is an interconnected group of nodes or neurons.

One embodiment provides a computer-implemented method that includes receiving, by a processor, an indication of one or more messaging applications to monitor, specifying a risk threshold. The processor further provides at least one notification to one or more devices, wherein the at least one notification comprises one or more identified scam messages from the one or more messaging applications. The processor additionally provides step-by-step guidance on actions to take to the one or more devices.

Another embodiment provides a method that includes receiving an indication of one or more messaging applications to monitor, specifying a risk threshold. The method further provides providing at least one notification to one or more devices. The at least one notification includes one or more identified scam messages from the one or more messaging applications. The method additionally provides step-by-step guidance on actions to take to the one or more devices.

Yet another embodiment provides an apparatus including a memory storing instructions, and at least one processor that executes the instructions including a process configured to receive an indication of one or more messaging applications to monitor, specifying a risk threshold. The processor is further configured to provide at least one notification to one or more devices. The at least one notification comprises one or more identified scam messages from the one or more messaging applications. The at least one processor is additionally configured to provide step-by-step guidance on actions to take to the one or more devices.

Some embodiments provide the feature of analyzing content of one or more messages received by the one or more devices through one or more communication channels for identifying one or more scam messages, and generating the one or more notifications for the one or more identified scam messages. The one or more notifications includes an alert.

One or more embodiments provide an additional feature that the alert includes one or more of: information about risk level for the one or more identified scam messages, a description of an identified threat, or recommended actions for a user to take in response.

Some embodiments provide the feature that analyzing of the content includes use of NLP to identify patterns or characteristics indicative of potential scams or fraudulent content.

One or more embodiments provide the feature that the one or more messages received by the one or more devices include at least one of text messages, emails, or messages from social media platforms. The one or more communication channels include a combination of one or more of mobile devices, desktop computing devices, or web-based applications.

Some embodiments provide the feature that the step-by-step guidance includes instructions for verifying the authenticity of the one or more received messages, reporting the one or more received messages, ignoring the one or more received messages, or taking other actions to prevent harm.

One or more embodiments provide the feature of providing a selection for a user to designate one or more guardians to receive the at least one notification for the one or more identified scam messages and to provide additional support to the user.

Some embodiments provide the feature that the analyzing content of one or more messages and generating the at least one notification are adaptable to different languages and regions for enabling multilingual support.

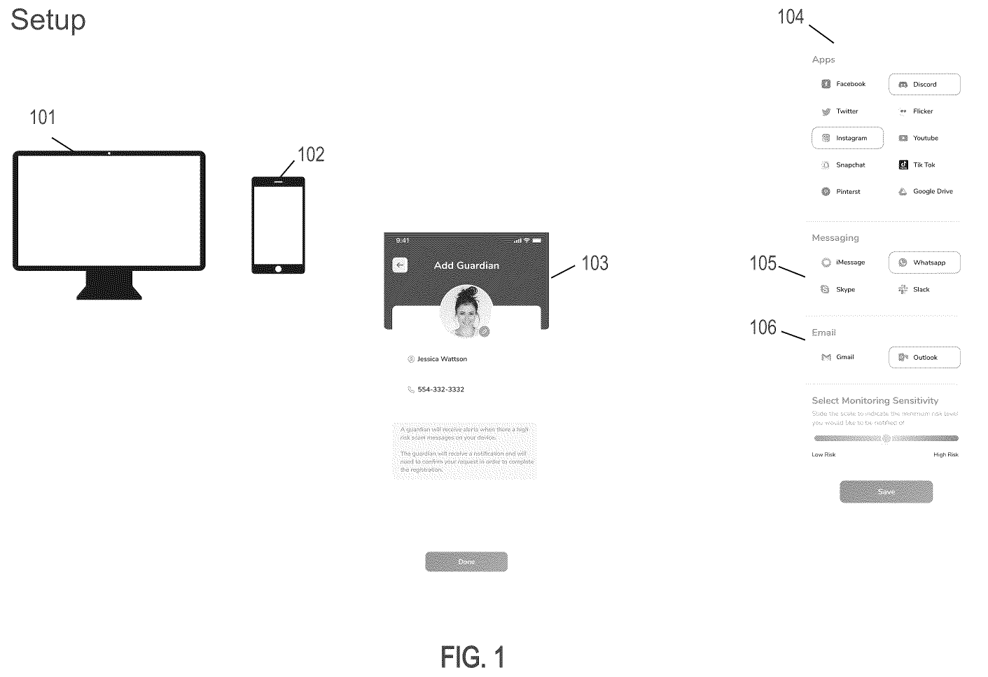

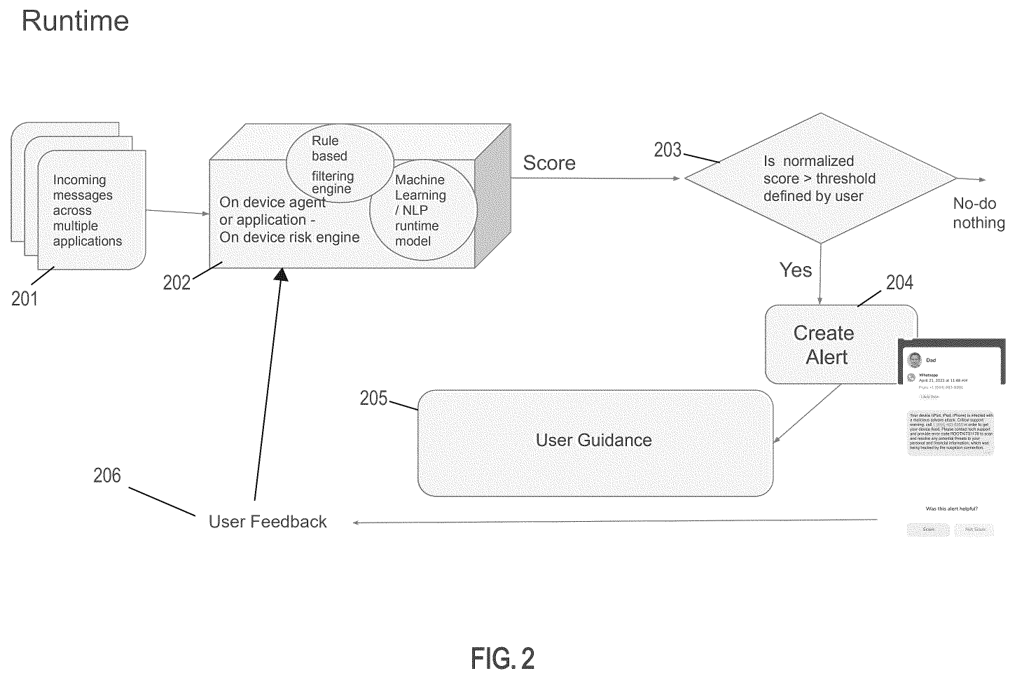

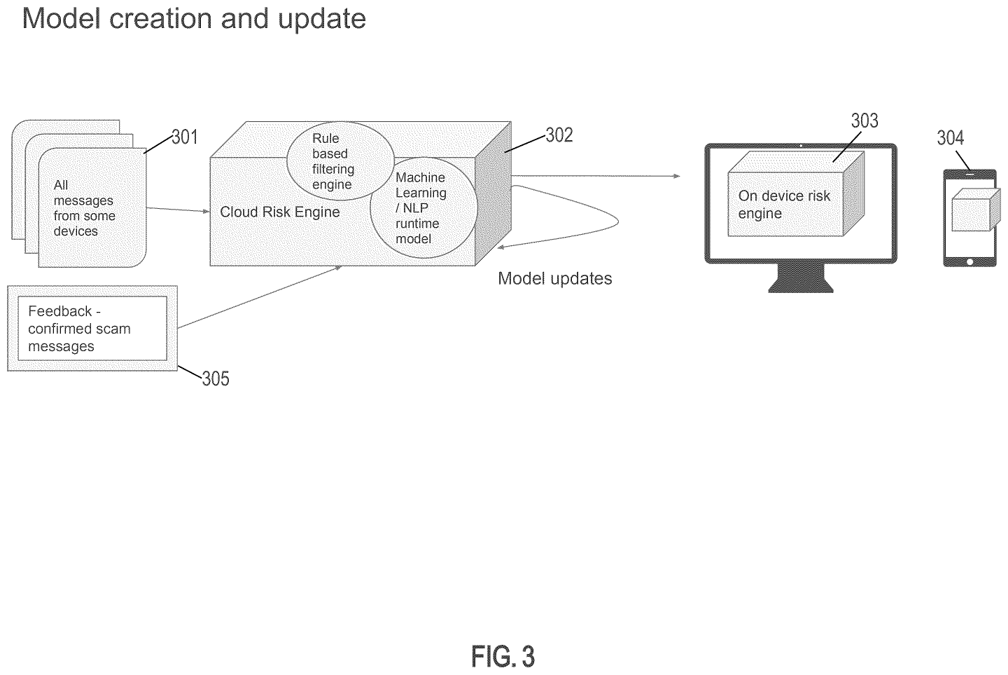

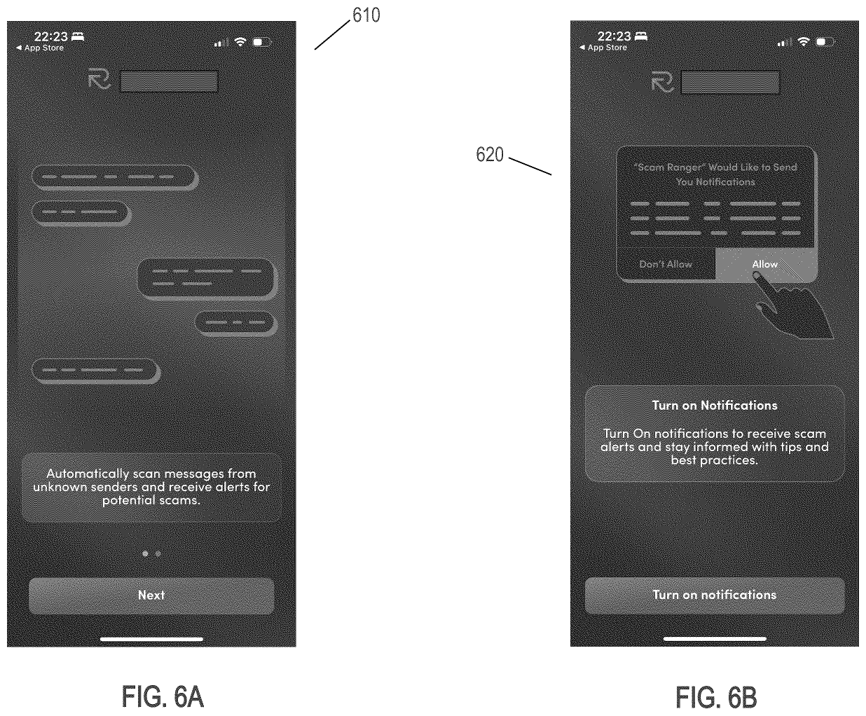

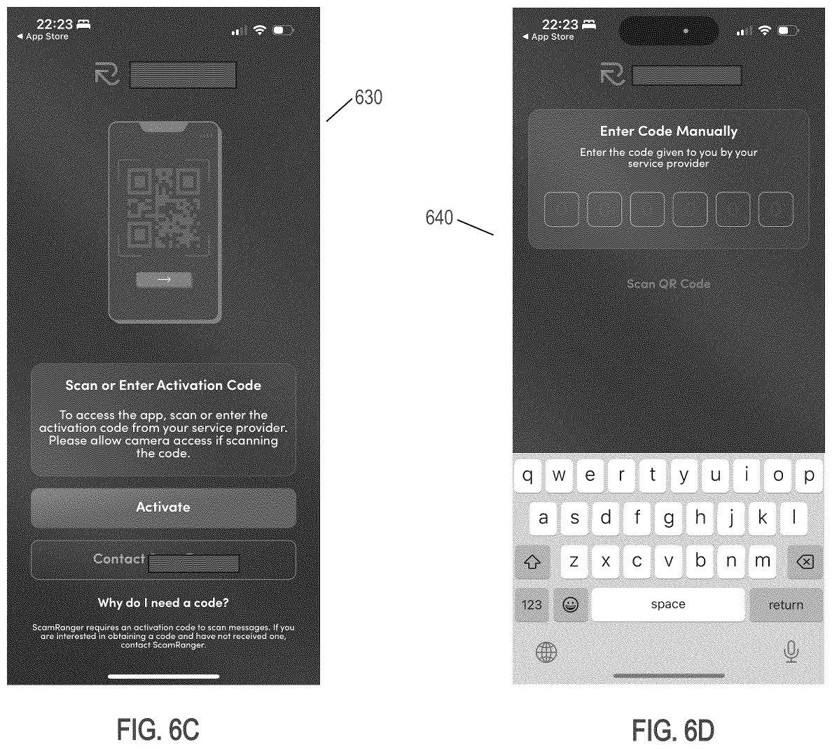

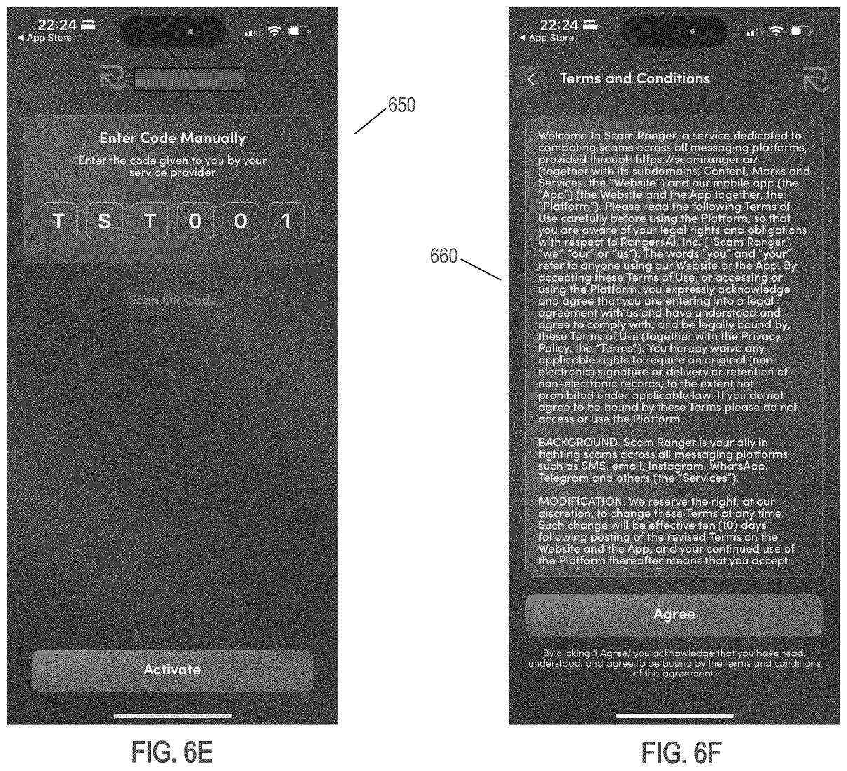

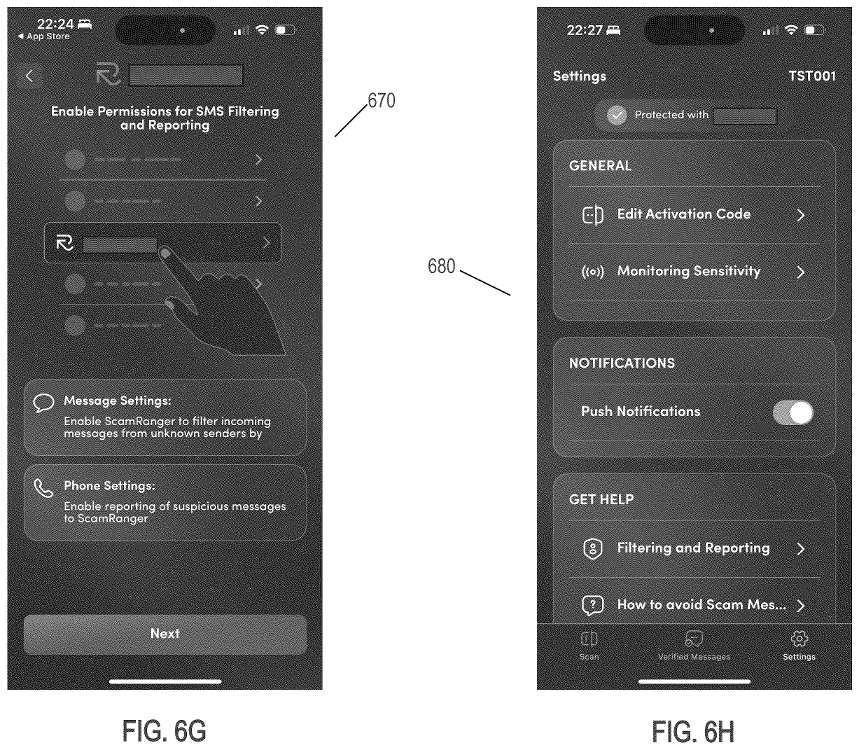

FIG. 1 is a schematic view of a flow diagram for a process for managing electronic messaging including a setup mode, according to some embodiments. In one or more embodiments, the process includes a set-up mode (FIG. 1), a runtime mode (FIG. 2), and a model creation and update mode (FIG. 3). In some embodiments, the set-up mode may contemplate a mobile device 102 application(s) (e.g. apps 104), desktop (computing device) 101 agent, mobile device software development kit (SDK), or the like. The set-up mode may include a user driven selection and consent configuration wherein the user of the system determines which messaging applications (e.g., messaging applications 105, email 106, etc.) will be monitored by the system (e.g., email, WHATSAPP®, SMS, etc.), and where users will add guardians 103 who will be trusted parties to help prevent a scam attempt. In one or more embodiments, users need to approve scanning of the messages from the messaging applications. In some embodiments, the setup mode includes activation processing where a mobile app requests that a user scan or enter an activation code (e.g., a scan of a QR code, a scan of a special image (e.g., animated, etc.), text (alphanumeric, special characters, etc.), etc. In one or more embodiments, the activation code may be provided to a user by a service provider, such as a bank, etc. (FIGS. 6C-E).

FIG. 2 is a continuation of FIG. 1, representing a runtime mode, according to some embodiments. In some embodiments, the runtime mode may include a configuration where once the system is set and active, incoming messages 201 are analyzed on the device (e.g., desktop 101, mobile device 102, etc.). In one or more embodiments, analysis can also occur on the server side or in a cloud computing environment. In some embodiments, analysis block 202 includes rule-based keyword filtering (e.g., via a rule-based filtering engine, etc.) and supervised (trained) ML (e.g., an NLP runtime model, etc.) based on a scored data set. In one or more embodiments, the system may use NLP to identify anomalies and patterns of potential scam messages. In addition, suspicious links are verified with known tools. The messages may receive a normalized score used to alert users based on their desired sensitivity of alerting. In block 203, upon a message exceeding the defined risk threshold, block 204 creates/generates an alert that is sent to the user (and guardian), where the user (and guardian) receives a notification of a message being high-risk. In some embodiments, the alerts may be obtained from pre-stored alerts. In block 205 step-by-step guidance is provided to the user to indicate how to check whether this is indeed a scam, based on the context. The user may provide feedback 206 determining whether the message is a potential scam or not, which then feeds the ML mechanism (e.g., for re-training). In one or more embodiments, the analysis functionality may be executed on-device, in a cloud computing environment using a service, etc. In some embodiments, one or more generative AI models may be implemented where such AI model(s) is trained with the system data. In one or more embodiments, a generative AI model fine tunes the system with proprietary data and classification.

FIG. 3 is a continuation of FIG. 2, including a model creation and update mode, according to some embodiments. In one or more embodiments, the model creation and update mode may include a configuration wherein a user may share data (all messages from some devices 301) with a cloud-based risk engine of block 302 that is utilized to continually learn about new scams and create the on-device risk engine 303/304 model. In one or more embodiments, both feedback 305 from confirmed scam messages and all messages for some users are sent to the cloud-based risk engine of block 302 for such analysis. Once the model is updated on the server, an updated on-device model is created and updated on the on-device risk engine 303/304 if an on-device model is employed. In other embodiments, the cloud risk engine model of block 302 updates and executes when an on-device model is not being used. In some embodiments, an alert is created, and in some cases the alert message is filtered into, for example, a junk folder. For example, for SMS on a smart phone, the system cannot send an alert due to the OS security limitations, but the system can move messages to, for example, the junk folder.

In some embodiments, there are three modes or phases: Setup mode/phase (FIG. 1)—wherein a user specifies which applications 104-106 to monitor and sets up guardians 103 (guardians are optional). Runtime mode/phase (FIG. 2)—wherein once a message is received in one of the applications (incoming messages 201) it is sent to block 202 for analysis to the device agent or application for analysis by the device risk engine (model) on-device via block 202 or in the cloud via block 302. Once the analysis is completed, a score is created. In one or more embodiments, if the score is above the sensitivity/risk level specified by the user (or initial system configuration) in block 203, an alert message is created (in block 204) to notify the user of a high-risk message, for example on the device (e.g., when the only option, etc.), on the server side (e.g., email), etc. In one example, the user may be notified by filtering email on the server side. In some embodiment, the setup for such alert messages can be made via a mobile app. In some embodiments, the alert message specifies the timestamp and location. In one or more embodiments, the alert message is created through the application, agent, or SDK in a mobile device app. In addition to the message, based on the context of the suspected scam message, step-by-step guidance is provided to the user (in block 205) such as-don't reply, stop, check, etc. In some embodiments, the user may provide feedback 206 (FIG. 2), such as confirming if the message is fraudulent. The user feedback 206 is provided to the device risk engine (block 202). The third part is the model creation mode/phase on the server (FIG. 3)—wherein an effective model is created based on input (all messages from some (e.g., thousands, etc.) devices 301) and analysis over that data, performed by data scientists (or artificial intelligence (AI), etc.), from multiple devices, which is sent/provided to a cloud analysis tool (block 302, the cloud risk engine (model)), which combines feedback 305 from many users and is updated from time to time based on new scam patterns. Once updated, in one or more embodiments a runtime version of the model (on-device risk engine 303/304) is created and sent to the agents/apps/SDKs on the endpoint devices.

In some embodiments, a goal is to identify scam messages to stop scams before users fall victim and get emotionally engaged in the scam, across different types of online message-initiated scams. As described above, there are three main phases: Setup (FIG. 1)-when a user specifies which applications to monitor on their device, set up guardians who will also get alerts and will be able to help them. This is targeted at vulnerable populations such as elderly, people who suffer from mental health or other issues. Users can also set up a threshold that determines the risk appetite they have-if the risk appetite is low, the threshold is low, and they receive more messages flagged as high-risk. In one or more embodiments, a default threshold may be set (e.g., a medium threshold).

Returning to FIG. 2, in one or more embodiments runtime-in this phase, once a message is received in one of the applications on the user's device it is sent for analysis to an on-device agent or application block 202, for analysis by the on-device risk engine (model). In some embodiments, the on-device risk engine (model) in block 202 is a combination of runtime ML and NLP algorithms/processes that are derived from a server side (cloud) instance of the risk engine. Additionally, in one or more embodiments, the risk engine includes a rules-based component that filters messages for keywords e.g., “time bombs” (do this now, or your account will be locked in an hour, etc.) this will elevate the risk of the message. In some embodiments, the analysis may be performed on a server or in a cloud computing environment, on the device (e.g., mobile device, desktop device, etc.), or a combination thereof. In one or more embodiments, the combined risk engine produces a risk score that is normalized (e.g., between 1-1000). If the message score is higher than the user or system defined risk threshold in block 203, an alert message is created in block 204. This message will appear on the user's device as an incoming notification (based on the alert systems available on the device, e.g., text message, email, sound/voice, haptic alert, etc.) and contains information (e.g., summarized, detailed, etc.). In some embodiments, when the user clicks on the notification, the agent or application opens with a screenshot of the message and step-by-step guidance in block 205 provided to the user indicating what the recommended actions are and what not to do. Once the user has completed the steps, they can provide feedback 206 whether the message was high-risk or not. The feedback will then be provided to the ML model and is also sent to the cloud/server risk engine service in block 202.

Returning to FIG. 3, in one or more embodiments model creation is provided on the server. A ML model is built/generated in a cloud instance that feeds from, for example, thousands, etc. of users and messages in block 301. Analysis is conducted over that data by data scientists, AI platforms, etc. In some embodiments, input to the risk engine in block 302 may include the following: messages, known malicious scams based on research and multiple offline data sources, feedback from users based on alerts, etc. This model is updated from time to time based on new scam patterns. Once updated, a runtime version of the model (on-device risk engine 303/304) is created and provided to the agents/apps/SDKs on the endpoint devices.

In one or more embodiments, there are a number of logic steps within the process, including but not limited to the following:
(a) Message risk analysis (and classification of scams):
   1. If known phrases, keywords, string operators (e.g., using logic such as contains, behind with, ends with, equals, etc.), etc. exist in messages—e.g., “time bombs” (do this now, your account will be locked in an hour, etc.) this will elevate the risk of the message;
   2. If the structure of the message is similar to previous scam messages; and
   3. At least one scam specific ML model based on NLP that is trained with a plethora (e.g., thousands, hundreds of thousands, etc.) of scam messages and learns scam patterns, scam issues, the specific scam categories, risk, etc., and may determine, for example, if the grammar is incorrect or language resembles commonly used phrases in scam conversations, etc.; if so, then more of these expressions are added as part of this model. In some embodiments, the scam may be classified (e.g., what scam this is exactly, etc.) so the system can determine a scam during runtime and provide the right context and education, which is distinguishable from conventional techniques;
(b) Threshold decision: If their score is higher than denoted by the threshold-initiate an alert message;
(c) Model update logic: When new scam messages are identified, the model is updated accordingly. It should be noted that the rules are tools for “zero day threats” where the ML model may not have enough messages on a new scam to feed/train/retrain the ML model. Once the ML model has enough messages, rules may not be needed in the system.

In some embodiments, through the analysis and classification of scams, during runtime the system determines what scam is received for determining the correct context and education for the user.

In one or more embodiments, the disclosed technology includes several components. One component provides the ability to read messages from multiple applications on the device. In some embodiments, each application needs a specific connector; and when a new application is launched in the market that allows messaging and potential risk for scams, a new connector is developed. For each message that is read, analysis needs to take place. The message is fed into the risk engine on the device, server or cloud computing environment. In one or more embodiments, the on-device risk engine is a runtime version and an inference from the server/cloud learning model. The rule-based part of the engine runs if-then-else-rules and assigns scores. In some embodiments, the runtime components are created with the applicable coding and development frameworks per device, per user, etc. User registration, configuration, and acceptance of a guardian setting are part of the application on-device but are also stored on the server to allow management and recovery. The server/cloud model is created using existing ML and NLP tools. The overall analysis of the generated scores is determined by a data sciences team upon model updates.

In one or more embodiments, connectors are implemented to read messages from applications, and a risk engine is implemented to analyze messages by the system.

In some embodiments, ML, large language models (LLMs) and NLP may not be necessary, but the efficacy is likely much higher with these models.

In one or more embodiments, the guardian function may not be required. However, in some cases of vulnerable users, the guardian function adds another layer of protection.

Some embodiments are designed to use technology to support users in real time and it requires multiple processes/steps. Another aspect is real time guidance—the disclosed technology may exist without this, but this element helps the user to understand what action to take.

In some embodiments, the two types of risk analysis are implemented-rules based and ML can be interchanged. However, the most effective way to create the risk engine is to combine both to be able to: (1) respond to “zero day” attacks, new patterns; and (2) not need to manage too many rules. In one or more embodiments, the data may be sent to the cloud for analysis, but this may slow down the process; and requiring all data to be sent to the cloud could provide privacy concerns in some scenarios.

In one or more embodiments, the disclosed technology includes a website or mobile application that analyzes messages submitted to the system, and the system identifies the risk level and recommends the next steps. The analytics is similar to that disclosed above, but some embodiments do not require proactive message filtering; instead, a user can check a message through the website and obtain the risk level and the next steps to take.

In some embodiments, the system and mobile app may be implemented in different languages depending on where they are deployed. In one or more embodiments, a user may selectively choose a preferred language for display purposes of the mobile app. In some embodiments, the system and mobile app are capable of receiving and analyzing messages in multiple languages for processing and determining risk level of the messages, and are adaptable to multiple regions.

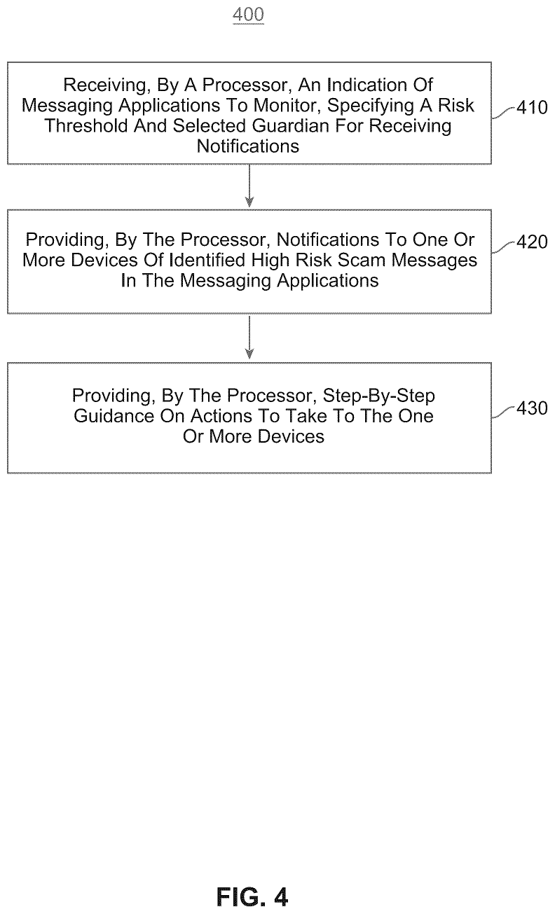

FIG. 4 illustrates a process 400 for distinguishing between scam messages and non-scam messages delivered via messaging platforms on mobile and desktop computing devices, according to some embodiments. Process 400 provides for a user of the disclosed technology to protect themselves from unfamiliar online scams. In block 410, the system is configured to define which messaging applications to monitor (e.g., email, SMS, WHATSAPP®, etc.), and to specify a risk threshold and, in some embodiments, guardians that receive notifications about high-risk messages. In block 420, process 400 provides that one or more devices receive notifications once high-risk scam messages are identified in messaging applications. In block 430, step-by-step guidance on what actions to take is provided to the one or more devices.

In some embodiments, process 400 provides the feature that a user provides feedback once the message is determined to be a scam message or not. In one or more embodiments, the feedback may be used to train/retrain the ML model. A selected guardian of the user is provided a notification and can contact the protected user to assist them to avoid the scam.

In one or more embodiments, process 400 includes the feature of identification of online predators, financial scams to users, and may also be used by business and corporations to prevent scams that target rogue access to the organization through personal employee devices.

In some embodiments, process 400 may provide for education about the scam and how it operates prior to step-by-step guidance.

In some embodiments, process 400 may provide the feature of analyzing content of one or more messages received by the one or more devices through one or more communication channels for identifying one or more scam messages, and generating the one or more notifications for the one or more identified scam messages. The one or more notifications includes an alert.

In one or more embodiments, process 400 may provide an additional feature that the alert includes one or more of: information about risk level for the one or more identified scam messages, a description of an identified threat, or recommended actions for a user to take in response.

In some embodiments, process 400 may further provide the feature that analyzing of the content includes use of NLP to identify patterns or characteristics indicative of potential scams or fraudulent content.

In one or more embodiments, process 400 may additionally provide the feature that the one or more messages received by the one or more devices include at least one of text messages, emails, or messages from social media platforms. The one or more communication channels include a combination of one or more of mobile devices, desktop computing devices, or web-based applications.

In some embodiments, process 400 may provide the feature that the step-by-step guidance includes instructions for verifying the authenticity of the one or more received messages, reporting the one or more received messages, ignoring the one or more received messages, or taking other actions to prevent harm.

In one or more embodiments, process 400 may additionally provide the feature of providing a selection for a user to designate one or more guardians to receive the at least one notification for the one or more identified scam messages and to provide additional support to the user.

In some embodiments, process 400 may further provide the feature that the analyzing content of one or more messages and generating the at least one notification are adaptable to different languages and regions for enabling multilingual support.

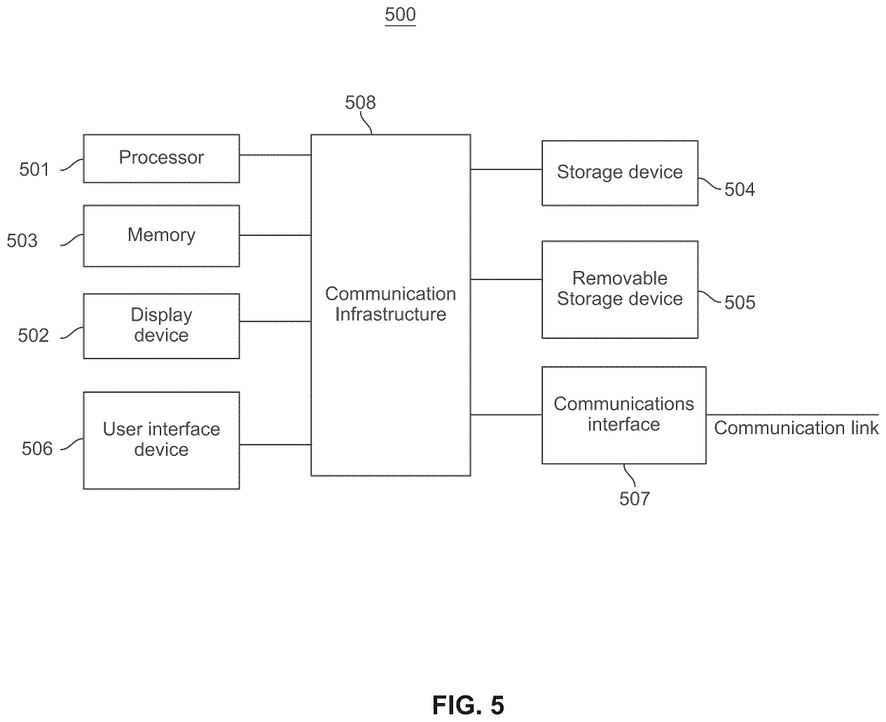

FIG. 5 is a high-level block diagram showing an information processing system comprising a computer system 500 useful for implementing the disclosed embodiments. Computer system 500 may be incorporated in an electronic device, such as a television, a sound bar, headphones, earbuds, tablet device, etc. The computer system 500 includes one or more processors 501, and can further include an electronic display device 502 (for displaying video, graphics, text, and other data), a main memory 503 (e.g., random access memory (RAM)), storage device 504 (e.g., hard disk drive), removable storage device 505 (e.g., removable storage drive, removable memory module, a magnetic tape drive, optical disk drive, computer readable medium having stored therein computer software and/or data), user interface device 506 (e.g., keyboard, touch screen, keypad, pointing device), and a communication interface 507 (e.g., modem, a network interface (such as an Ethernet card), a communications port, or a PCMCIA slot and card). The communication interface 507 allows software and data to be transferred between the computer system and external devices. The system 500 further includes a communications infrastructure 508 (e.g., a communications bus, cross-over bar, or network) to which the aforementioned devices/modules 501 through 507 are connected.

Information transferred via communications interface 507 may be in the form of signals such as electronic, electromagnetic, optical, or other signals capable of being received by communications interface 507, via a communication link that carries signals and may be implemented using wire or cable, fiber optics, a phone line, a cellular phone link, a radio frequency (RF) link, and/or other communication channels. Computer program instructions representing the block diagram and/or flowcharts herein may be loaded onto a computer, programmable data processing apparatus, or processing devices to cause a series of operations performed thereon to produce a computer implemented process.

In some embodiments, processing instructions for process 400 (FIG. 4) may be stored as program instructions on the memory 503, storage device 504 and the removable storage device 505 for execution by the processor 501.

In one or more embodiments, the network utilized by computer system 500 may refer to any interconnecting system capable of transmitting audio, video, signals, data, messages, or any combination of the preceding. The network may include all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, or any other suitable communication link, including combinations thereof.

In some embodiments, a server and computer of the computer system 500 may each include computing systems. Any suitable number of computing systems may be utilized. The computing system 500 may take any suitable physical form. In one or more embodiments, the computing system 500 may be a virtual machine (VM), an embedded computing system, a system-on-chip (SOC), a single-board computing system (SBC) (e.g., a computer-on-module (COM) or system-on-module (SOM)), a desktop computing system, a laptop or notebook computing system, a smart phone, an interactive kiosk, a mainframe, a mesh of computing systems, a server, an application server, a combination of two or more thereof, etc. Where appropriate, the computing systems may include one or more computing systems; be unitary or distributed; span multiple locations; span multiple machines; or reside in a cloud, which may include one or more cloud components in one or more networks. Where appropriate, one or more computing systems may perform without substantial spatial or temporal limitation one or more processes or steps of one or more methods described or illustrated herein. As an example, and not by way of limitation, one or more computing systems may perform in real time or in batch mode one or more processes or steps of one or more methods described or illustrated herein. One or more computing systems may perform at different times or at different locations one or more processes or steps of one or more methods described or illustrated herein, where appropriate.

In some embodiments, the computing systems may execute any suitable operating system such as IBM's zSeries/Operating System (z/OS), MS-DOS, PC-DOS, Mac-OS, Windows, Unix, OpenVMS, an operating system based on Linux, or any other appropriate operating system, including future operating systems. In some embodiments, the computing systems may include a web server running web server applications such as Apache, Microsoft's Internet Information Server™, and the like.

In one or more embodiments, each computing system includes a processor, a memory, a user interface and a communication interface. In some embodiments, the processor includes hardware for executing instructions, such as those making up a computer program. The memory includes main memory for storing instructions such as computer program(s) for the processor to execute, or data for processor to operate on. The memory may include mass storage for data and instructions such as the computer program. As an example and not by way of limitation, the memory may include an HDD, a floppy disk drive, flash memory, an optical disc, a magneto-optical disc, magnetic tape, a Universal Serial Bus (USB) drive, a solid-state drive (SSD), or a combination of two or more of these. The memory may include removable or non-removable (or fixed) media, where appropriate. The memory may be internal or external to computing system, where appropriate. In one or more embodiments, the memory is non-volatile, solid-state memory.

In some embodiments, the user interface device 506 may include hardware, software, or both providing one or more interfaces for communication between a person and the computer systems. As an example, and not by way of limitation, a user interface device 506 may include a keyboard, keypad, microphone, monitor, mouse, printer, scanner, speaker, still camera, stylus, tablet, touchscreen, trackball, video camera, another suitable user interface, a combination of two or more thereof, etc. A user interface may include one or more sensors.

In one or more embodiments, the communications interface 507 may include hardware, software, or both providing one or more interfaces for communication (e.g., packet-based communication) between the computing systems over the network. In some embodiments, the communication interface may include a network interface controller (NIC) or network adapter for communicating with an Ethernet or other wire-based network or a wireless NIC (WNIC) or wireless adapter for communicating with a wireless network, such as a WI-FI network. The disclosed technology contemplates any suitable network and any suitable communication interface. As an example, and not by way of limitation, the computing systems may communicate with an ad hoc network, a personal area network (PAN), a local area network (LAN), a wide area network (WAN), a metropolitan area network (MAN), one or more portions of the Internet, or a combination of two or more thereof, etc. One or more portions of one or more of these networks may be wired or wireless. As an example, the computing systems may communicate with a wireless PAN (WPAN) (e.g., a BLUETOOTH® WPAN), a WI-FI network, a WI-MAX network, a cellular telephone network (e.g., a Global System for Mobile Communications (GSM) network), other suitable wireless network, or a combination of two or more thereof, etc. The computing systems may include any suitable communication interface for any of these networks, where appropriate.

FIG. 6A shows an example screen view 610 of a mobile app that shows an initial startup display, according to some embodiments.

FIG. 6B shows an example screen view 620 of a mobile app that shows another initial display providing a selection for turning on notifications to receive scam alerts, information and tips, according to some embodiments.

FIG. 6C shows an example screen view 630 of a mobile app for scanning an activation code (e.g., from a QR code, etc.), an activate button, a contact button and information, according to some embodiments. In some embodiments, the setup includes a request for an activation code, a scan of a QR code, a special image (e.g., animated, etc.), etc. In one or more embodiments, the activation code may be provided to a user by a service provider, such as a bank, etc.

FIG. 6D shows an example screen view 640 of the mobile app showing a request to manually enter an activation code. In some embodiments, the service provider customers may be provided with an activation code, such as a combination of one or more of numbers, letters, and special characters. In one embodiment, the mobile device 102 application (FIG. 1) requests an activation code, which obviates the need to collect any user data, which ensures privacy by design.

FIG. 6E shows an example screen view 650 of the mobile app showing a manually entered activation code and an activate button.

FIG. 6F shows an example screen view 660 that shows an example terms and conditions and an agree button for accepting the terms and conditions.

FIG. 6G shows an example screen view 670 that shows a permissions page for enabling permissions for SMS filtering and reporting, a button for message settings and a button for phone settings.

FIG. 6H shows an example screen view 680 that shows a settings page for selecting general settings (e.g., edit activation code, monitoring sensitivity, etc.), notification settings (e.g., settings for allowing push notifications, etc.), a get help menu for receiving help with filtering and reporting, information for how to avoid scam messages, etc.

Multi-tenant platform: Since organizations may provide the mobile app to their customers or employees, the system is multi-tenant. Each tenant can manage and edit the recommended next steps with their messaging, including the creation and distribution of activation codes to users, edit the recommended next steps with their messaging, create message filtering rules unique to their tenant, create allow rules for certain message constructs that will not be blocked by the solution (e.g. marketing messages from the tenant). Analytics over collected data: Given that the system collects data on consumer scams (data is anonymized) analytics are created over this data: top scam types across all users, top scam types for a certain institution (targeting their customers), top messages including brand impersonation for a certain customers, etc. This analysis allow the organization to quickly implement education to their customer support/frontline teams and customers. Risk signals to expand visibility across the scam lifecycle. Since this solution is meant to be used by financial institution consumers, the system connects the risk on the user's device with the financial activity conducted by the user. This is done using the activation code, where the financial institution can map which user was provisioned with which code. For example: If a user received a gift card scam message, asking them to buy a gift card to pay the criminal, and a few days later the customer will buy gift cards (either online or in the store), a connection can be made by these two data points if that information is shared with the financial institution. This de-facto expands the visibility of the financial institution to better understand risk. Data may be provided to say whether the user interacted with the app to learn more about the scam or what feedback they provided.

Embodiments have been described with reference to flowchart illustrations and/or block diagrams of methods, apparatus (systems) and computer program products. Each block of such illustrations/diagrams, or combinations thereof, can be implemented by computer program instructions. The computer program instructions when provided to a processor produce a machine, such that the instructions, which execute via the processor create means for implementing the functions/operations specified in the flowchart and/or block diagram. Each block in the flowchart/block diagrams may represent a hardware and/or software module or logic. In alternative implementations, the functions noted in the blocks may occur out of the order noted in the figures, concurrently, etc.

The term “approximately” may include deviations of up to 10 percent of a provided value.

The terms “computer program medium,” “computer usable medium,” “computer readable medium”, and “computer program product,” are used to generally refer to media such as main memory, secondary memory, removable storage drive, a hard disk installed in hard disk drive, and signals. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Computer program instructions may be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

As will be appreciated by one skilled in the art, aspects of the embodiments may be embodied as a system, method or computer program product. Accordingly, aspects of the embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the embodiments may take the form of a computer program product embodied in one or more computer readable medium(s) having computer readable program code embodied thereon.

Any combination of one or more computer readable medium(s) may be utilized. The computer readable medium may be a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Computer program code for carrying out operations for aspects of one or more embodiments may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of one or more embodiments are described above with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various embodiments. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

References in the claims to an element in the singular is not intended to mean “one and only” unless explicitly so stated, but rather “one or more.” All structural and functional equivalents to the elements of the above-described exemplary embodiment that are currently known or later come to be known to those of ordinary skill in the art are intended to be encompassed by the present claims. No claim element herein is to be construed under the provisions of 35 U.S.C. section 112, sixth paragraph, unless the element is expressly recited using the phrase “means for” or “step for.”

The terminology used herein is for the purpose of describing particular embodiments only and is not intended to be limiting of the disclosed technology. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the embodiments has been presented for purposes of illustration and description, but is not intended to be exhaustive or limited to the embodiments in the form disclosed. Many modifications and variations will be apparent to those of ordinary skill in the art without departing from the scope and spirit of the disclosed technology.

Though the embodiments have been described with reference to certain versions thereof; however, other versions are possible. Therefore, the spirit and scope of the appended claims should not be limited to the description of the preferred versions contained herein.

What is claimed is:

1. A computer-implemented method comprising:
receiving, by a processor, an indication of one or more messaging applications to monitor, specifying a risk threshold;
providing, by the processor, at least one notification to one or more devices, wherein the at least one notification comprises one or more identified scam messages from the one or more messaging applications; and
providing, by the processor, step-by-step guidance on actions to take to the one or more devices.

2. The computer-implemented method of claim 1, further comprising:
analyzing content of one or more messages received by the one or more devices through one or more communication channels for identifying the one or more scam messages; and
generating the at least one notification for the identified one or more scam messages; wherein the at least one notification includes an alert.

3. The computer-implemented method of claim 2, wherein the alert including one or more of: information about risk level for the one or more identified scam messages, a description of an identified threat, or recommended actions for a user to take in response.

4. The computer-implemented method of claim 2, wherein the analyzing of the content includes use of natural language processing (NLP) to identify patterns or characteristics indicative of potential scams or fraudulent content.

5. The computer-implemented method of claim 2, wherein the one or more messages received by the one or more devices include at least one of text messages, emails, or messages from social media platforms, and the one or more communication channels include a combination of one or more of mobile devices, desktop computing devices, or web-based applications.

6. The computer-implemented method of claim 2, wherein the step-by-step guidance includes instructions for verifying the authenticity of the one or more received messages, reporting the one or more received messages, ignoring the one or more received messages, or taking other actions to prevent harm.

7. The computer-implemented method of claim 1, further comprising providing a selection for a user to designate one or more guardians to receive the at least one notification for the one or more identified scam messages and to provide additional support to the user.

8. The computer-implemented method of claim 1, wherein the analyzing content of one or more messages and generating the at least one notification are adaptable to different languages and regions for enabling multilingual support.

9. A method comprising:
receiving an indication of one or more messaging applications to monitor, specifying a risk threshold;
providing at least one notification to one or more devices, wherein the at least one notification comprises one or more identified scam messages from the one or more messaging applications; and
providing step-by-step guidance on actions to take to the one or more devices.

10. The method of claim 9, further comprising:
analyzing content of one or more messages received by the one or more devices through one or more communication channels for identifying the one or more scam messages; and
generating the at least one notification for the identified one or more scam messages; wherein the at least one notification includes an alert.

11. The method of claim 10, wherein the alert including one or more of: information about risk level for the one or more identified scam messages, a description of an identified threat, or recommended actions for a user to take in response.

12. The method of claim 10, wherein the analyzing of the content includes use of natural language processing (NLP) to identify patterns or characteristics indicative of potential scams or fraudulent content.

13. The method of claim 10, wherein the one or more messages received by the one or more devices include at least one of text messages, emails, or messages from social media platforms, and the one or more communication channels include a combination of one or more of mobile devices, desktop computing devices, or web-based applications.

14. The method of claim 10, wherein the step-by-step guidance includes instructions for verifying the authenticity of the one or more received messages, reporting the one or more received messages, ignoring the one or more received messages, or taking other actions to prevent harm.

15. The method of claim 9, further comprising providing a selection for a user to designate one or more guardians to receive the at least one notification for the one or more identified scam messages and to provide additional support to the user.

16. The method of claim 9, wherein the analyzing content of one or more messages and generating the at least one notification are adaptable to different languages and regions for enabling multilingual support.

17. An apparatus comprising:
a memory storing instructions; and
at least one processor executes the instructions including a process configured to:
receive an indication of one or more messaging applications to monitor, specifying a risk threshold;
provide at least one notification to one or more devices, wherein the at least one notification comprises one or more identified scam messages from the one or more messaging applications; and
provide step-by-step guidance on actions to take to the one or more devices.

18. The apparatus of claim 17, wherein:
the process is further configured to:
analyze content of one or more messages received by the one or more devices through one or more communication channels for identifying the one or more scam messages; and
generate the at least one notification for the identified one or more scam messages; wherein the at least one notification includes an alert; and
the alert including one or more of: information about risk level for the one or more identified scam messages, a description of an identified threat, or recommended actions for a user to take in response.

19. The apparatus of claim 18, wherein:
the analysis of the content includes use of natural language processing (NLP) to identify patterns or characteristics indicative of potential scams or fraudulent content;
the one or more messages received by the one or more devices include at least one of text messages, emails, or messages from social media platforms;
the one or more communication channels include a combination of one or more of mobile devices, desktop computing devices, or web-based applications; and
the step-by-step guidance includes instructions for verifying the authenticity of the one or more received messages, reporting the one or more received messages, ignoring the one or more received messages, or taking other actions to prevent harm.

20. The apparatus of claim 17, wherein:
the processor is further configured to:
provide a selection for a user to designate one or more guardians to receive the at least one notification for the one or more identified scam messages and to provide additional support to the user; and
the analysis of content of one or more messages and the generation of the at least one notification are adaptable to different languages and regions for enabling multilingual support.
